(19) United States
(12) Patent Application Publication
(10) Pub. No.: US 2021/0278666 A1
(43) Pub. Date: Sep. 9, 2021

(54) A Display System

(71) Applicant: Thales Holdings UK Plc, Reading, Berkshire (GB)

(72) Inventor: John Foley, Reading, Berkshire (GB)

(21) Appl. No.: 16/624,645

(22) PCT Filed: Jul. 3, 2018
(86) PCT No.: PCT/GB2018/051869

§ 371 Date: Dec. 19, 2019

(30) Foreign Application Priority Data
Jul. 6, 2017 (GB) 1710890.3

(51) Int. Cl. G02B 27/01; G02B 27/00; G06F 3/01; G01C 21/00; G09G 3/34

(52) U.S. Cl. CPC G02B 27/0172; G02B 27/0093; G06F 3/013; G09G 2320/0626; G09G 3/3426; G02B 2027/0141; G02B 2027/014; G01C 21/38

(57) ABSTRACT

A display system is described, for placement of a display above, below or beside the normal gaze of a user, to impart simple information to the user by means of selective driving of a plurality of light emitting elements.

### FIELD

Embodiments described herein relates to a display system. In particular, embodiments described herein comprise a device which can provide a user with information in a simple format while avoiding occlusion of the user's visual field.

### BACKGROUND

There are various methods available for providing information in a visual form to users. For instance, helmets/head mounted displays (HMD) have been used for some time, most notably by crewmembers of fixed and rotary wing aircraft.

HMD's have also been used in other contexts, such as in civilian and commercial roles, where it is desirable to provide users with information without those users having to distract themselves from a manual task in hand.

### SUMMARY

In general terms, embodiments described herein provide a display system for placement of a display above, below or beside the normal gaze of a user, to impart simple information to the user by means of selective driving of a plurality of light emitting elements.

### DRAWINGS

Drawings illustrating exemplary specific embodiments are appended hereto.

FIG. 1 is a schematic general arrangement of a display system of an embodiment described herein;

FIG. 2 is a sectional view of a helmet on a user's head, implementing the display system illustrated in FIG. 1;

FIG. 3 is a view, from a user's perspective, of a display unit of the display system of FIGS. 1 and 2;

FIG. 4 is a schematic drawing of a torso mounted control box of the display system illustrated in FIGS. 1 and 2;

FIG. 5 is a schematic architecture of a helmet mounted display control unit of the display system illustrated in FIGS. 1 and 2;

FIG. 6 is a functional architecture of the helmet mounted display control unit of FIG. 5; and

FIG. 7 is a flow diagram of a process for determining and indicating a bearing to a user.

### DESCRIPTION OF SPECIFIC EMBODIMENTS

An aspect disclosed herein is intended to provide benefits to users through the use of simple visual cues and the implementation of this nonintrusive manner by fitting an array of small light sources (typically LEDs) around the inside of the brow of the user's helmet (or similar). Desirably, a display device incorporating this array can be configured to communicate with other interface devices provided to the user, such as a handheld display which might be affixed to the wrist of the user or mounted to their chest in a “look down” configuration. In this way, simple information can be signalled to the user, complementing the conveyance of more complex information through another device. For very simple elements of information this device may also be used as the sole display mechanism.

This means that, whereas a user may have a single interface device, such as a smart phone (which may be modified to specific circumstances), having the capability of providing simple and complex information to user, scenarios may arise in which a user is required to receive simple instructions or information, and a complex user interface such as a smart phone is vastly more complex than required to fulfill this task. Furthermore, such simple instructions may need to be provided to the user without distracting the user from a task in hand. Such a task in hand may require the user's undivided attention, and/or may be difficult to disengage with because it requires the user to employ both hands. It is undesirable for a user to have to cease such a task in hand, to focus attention on a smart phone. The user might be required to interact with the smart phone to obtain the information. If the information is simply “Beware Oncoming Train”, conveying this information by handheld device is both inefficient and less impactful than required.

It is therefore desirable to supplement this communication facility with a further facility for conveying simple instructions and/or information to the user. This can be a stand-alone device, or could integrate with existing equipment. It offers the opportunity to provide a means to convey time critical data to the user with minimal delay, compared to the time lag that may occur when the user is expected to use a handheld display.

Throughout this disclosure, reference is made to LEDs as point light sources in embodiments described herein. However, the reader will appreciate that embodiments can be implemented with any suitable point light sources, based on any form of light-emitting technology. Fibre optics may be used, the tips of optical fibres offering the facility to display points of light to users. The phrase “point sources” is intended to cover all light-emitting options (for example bars, squares, ovals) which can be separated in space by the viewer such that they can be used to convey data.

Furthermore, throughout this disclosure, reference is made to the point light sources being fitted within a “helmet”. It will be understood by the reader that any form of headwear can be used for implementation of embodiments. For example, this might include other forms of protective headgear (for example cycle helmets), any form of hat or head mounted framework (for example respirator), or spectacles, goggles and any other form of eyewear.

Additionally, embodiments described herein include an array of point sources positioned horizontally in front of the user's brow, just above their normal eye line, where they can be seen in peripheral vision or by glancing upwards. Similar benefits may be delivered by alternative implementations which achieve similar results by positioning point sources in other locations around the user central area of vision, for example below the eye line, at the sides of the visual area, and so on. Such approaches might be adopted to suit specific circumstances, for example when wearing a respirator.

Whereas embodiments described herein relate to a plurality of point light sources, if a single device were implemented with the facility to replicate the function of a plurality of point light sources, this would also form an embodiment.

Facilities provided by the embodiments can be used flexibly and selectively. For example, personnel seeking to engage in detailed evaluation of a local environment, for example evaluating positions on a map, may find it more appropriate to use a handheld display. However, such personnel may need to be advised if threats, dangers or other points of interest should be taken into account. Depending on the immediacy and or simplicity of the information to be conveyed to the users, head mounted displays of the form described in the present disclosure may be more appropriate.

Military applications for the technology can be contemplated. Dismounted infantry may use the devices disclosed herein to obtain simple information, such as proposed direction of travel, direction of threat, low-power alert, or an indicated need to access the handheld display. Using the device, a user can retain full awareness of their immediate surroundings without being distracted by complex information on a full screen display. The need to provide operatives, who may have limited expertise in use of technology, with high technology solutions such as smartphones and tablets, may thus be reduced or eliminated altogether.

Single or multiple rows of point light sources can be used to convey direction, status and alert information. Different colour (or multicolour) LEDs can be used, depending on requirements and circumstances. Of course, such implementations may be inappropriate in circumstances where users susceptible to colour blindness may be encountered.

The LEDs described herein can be integrated into a mount, which can be a simple backing strip for affixing to the inside or underside of the brow of a helmet. The backing strip can be treated with an adhesive layer, to provide an adhesion facility for a user. This enables the device to be fitted to a helmet without need for modification of the helmet and compromise of its primary protective functions. Alternative fixing methods would include the use of simple clip-on mechanisms or mechanical attachment to existing fixing points on the helmet.

The point light sources may be capable of generating light at varying brightness. The brightness of the LEDs, in use, can be controlled, in certain embodiments, with reference to a measure of ambient light conditions. Measurement of ambient light conditions may be achieved by means of an ambient light sensor, which can be integrated into the array of LEDs. Overall control of brightness may be achieved by use of user control. An electronic unit can be fitted in the helmet, connected to other electronic data systems on the person of the user, to manage LED illumination status.

In certain embodiments, the LEDs may illuminate only for short periods of time. This means that they attract the attention of the user when they illuminate. This militates against the possibility that, if the LEDs are illuminated constantly, the user may become inured to their presence, hence reducing their signalling impact on the user. On the other hand, the continuous presence of an illuminated LED may distract the user; an illuminated light source can attract the attention of a user long after the information conveyed by the light source has been digested. Moreover, as will be appreciated by the reader, if the period of illumination remains short, power can be conserved. It also means that the light emitted by the LEDs is less likely to be detected by third parties.

The LEDs may illuminate only when information is to be conveyed. That is, in normal use, when no immediate signal needs to be conveyed, all LEDs can be extinguished. There may be a facility for a user to initiate an input action to cause the LEDs to illuminate. There may be a user-defined setting to determine whether the LEDs are illuminated only briefly, or are more persistent.

It is intended that the user can immediately see the array of illuminated LEDs in their peripheral vision, or by simply glancing up (without the need to refocus) and with the minimum of distraction to their primary task of observing their immediate surroundings, or focusing on another task in hand.

The reader will appreciate that the information types which could be conveyed to the user are numerous. The number of different types of information probably depends on the level of sophistication of the user, and particularly their skills at perception. For instance, a motor racing driver could be expected to have higher levels of perception than a railway maintenance worker, and so the capabilities of the system would need to be configured accordingly.

Warning alerts could be conveyed to the user, by illuminating specific LEDs in the array. Colour coding could be used to distinguish between particular warnings. Such warnings may include:
low-power warning
loss of GPS warning
loss of radio contact warning
threat warning
refer to handheld display as soon as possible for more complex information
other warnings to be determined by the user or system configurator

The system as disclosed herein can be integrated with navigation facilities, and navigation cues can be conveyed to the user. For instance, if a navigation system has been configured with a waypoint or target to which the user is intended to travel, or to which the user's attention should be directed, information conveying to the user the direction to that waypoint or target can be indicated by illumination of one or more LEDs which best align to that direction. It will be appreciated that the accuracy which this approach to the conveying of information can deliver may be relatively modest. If the user is oriented in an entirely different direction to that desired or intended, this could be indicated by illuminating one or more LEDs at the extreme end of the array corresponding to the direction to which the user should turn. There may also be a way of coding the approximate range to the desired waypoint. This could be by way of a flashing light pattern, a colour pattern, or a spatial light pattern. So, for instance, a distant waypoint may be indicated by red light, a close waypoint may be indicated by green light, and other colours may be used to indicate ranges between those extremes. Other information can also be conveyed to the user, such as the existence, and or direction of other personnel of which the user should have knowledge.

In summary, all of these are simple pieces of information, using simple data indicators, which the user can rapidly assimilate, while remaining in a dynamic status, with minimal distraction from a critical task in hand. It will be appreciated that embodiments need not implement all of the above possibilities. The number of pieces of information which a system can or should convey to the user will depend upon the capabilities of the user, and the circumstances of use.

Embodiments described herein can also be used as a pointing aid. That is, a device in accordance with the disclosure can be used to track and indicate the direction of specified objects in relation to the user's helmet, when the latter is fitted with a directional sensor. It is important to note that the device does not seek to offer precise direction cues. By its very nature, it is intended to provide an approximate directional cue, accurate at best to few degrees, for instance 5°. This low precision cueing is adequate for conveying simple “general direction” data, similar to that given by a colleague pointing with their arm, and very easily assimilated. It also has the major benefit of not needing to retain highly accurate calibration of the direction finding sensors, which are notoriously prone to drift; the impact of the inaccuracy of such sensors is greatly reduced by the lower expectations for precision to be delivered by the device the subject of this disclosure.

Embodiments described herein can also be used to allow a user to avoid frequent reference to any handheld display in a “heads down” mode. Using a handheld display, such as smart phone, can be dangerous in circumstances in which a user must not be distracted from a task in hand. This task in hand could be surveillance of a scene of interest, or maintenance and/or repair of complex equipment. In such circumstances, it is inconvenient, inappropriate and possibly dangerous for a user to be distracted by the need to obtain further information from a complex display device. Instead, embodiments such as described herein offer an opportunity for a device to be provided to the user which can convey simple information without distraction.

A device in accordance with embodiments described herein can signal to a user, as alluded to above, that a more complex piece of information is available to be obtained from a more sophisticated display device, such as a smart phone. This means that, not only does a user not need to be distracted by non-time critical information arriving on a complex display device, he can also refer to the complex device at a time of his own choosing.

For instance, at present, a surgeon may be reliant on other personnel, or audible alerts, if vital information concerning a patient needs to be acquired. So, for example, if a patient's heart rate falls below a certain threshold, currently this must be conveyed either by an audible alarm or by another person raising an alarm. With an embodiment such as described herein, a surgeon's visor or spectacles could be fitted with a simple display which could convey such alarm information to the surgeon quickly and without need to distract from the primary task in hand.

Inserting the display device within a helmet, and thus against the background of the interior of the helmet, also offers a benefit in that the light sources can be made relatively low intensity and still remain visible to the user. This can be useful in that it avoids illumination of the user's face to third parties.

Whereas several of the embodiments described herein involve a one-dimensional (1-D) array of light sources (that is, a row), 2-D formats can also be contemplated. In a 2-D format, a 2-D array of light sources may offer several rows of lights above each other in order to convey more complex information when required. The 1-D array offers the benefits of simplicity and reduced “real estate” requirements on the helmet brow. The lights could be point sources or controlled “bars” of light. Light sources could be monochrome or multicolour.

The use of an ambient light sensor conjunction with the LEDs or other light sources, can control the brightness of the array of light sources, to adapt them to the external brightness conditions. This could be provided in conjunction with an override control, for use by the user, to enable the user to adapt brightness to suit user preferences.

The type of information to be conveyed to the user, by the display device of embodiments disclosed herein, may be configured by the user. A user interface may offer options for the manner in which data display can be controlled. Users may request some data types such as navigation cues, and the system will display requested data for a pre-specified period of time (or, alternatively, indefinitely until cancelled by a user). The system may be preset to illuminate certain warning or alert lights, such as if system power is low. A facility may be provided for conveying information to user by audio, such as an earpiece. Audio prompts may be output to the user, in conjunction with the illuminated warnings described above. A user may be provided with a facility to selectively enable and/or disable certain display functions, as the need arises.

In certain circumstances, point light sources located between the eyes of a user (for instance in the bridge region of a set of spectacles) can cause visual confusion and multiple images. It is therefore desirable to avoid these problems arising. Eye separation and eye location vary from user to user. So, it is desirable for the device to accommodate users with different ocular separation and location. One approach would be to provide two point light arrays, one per eye. The user will then be able to fit each point light array above respective eyes. An alternative approach is to provide a single point light array, and to use the process through driving electronics, to tailor the choice as to which LEDs light up to each user. This would enable a median portion of the array to be left extinguished, and this median portion could be adjusted for comfort.

As noted above, audio output to the user may enhance the device as described herein, such as the provision of an audio cue to a user when visual data as displayed on the point light array changes, or when specific types of data or warning or updated. Very short, simple audio tone can alert the user to the presence of new data on the array. Audio messages may also be used to convey additional data relating to the simple visual cue. For example, an audio message might state the size and nature of a threat to the user. Another option might be an audio message giving distance when a waypoint is cued. The system setup can be adjusted to tailor these for specific applications.

Embodiments as described herein offered the opportunity for devices to be provided which are simple, low-cost, low weight and easy to use. Interpretation and assimilation of information conveyed by such device can be made easy. The use of simple technology provides low demand on power. It is easily fitted within a user helmet, without impacting on helmet protective integrity. Maintenance is straightforward, and it is relatively straightforward to adapt to different and/or evolving functions. Because of its simplicity, users can be trained to use the device straightforwardly. Specific embodiments will now be described.

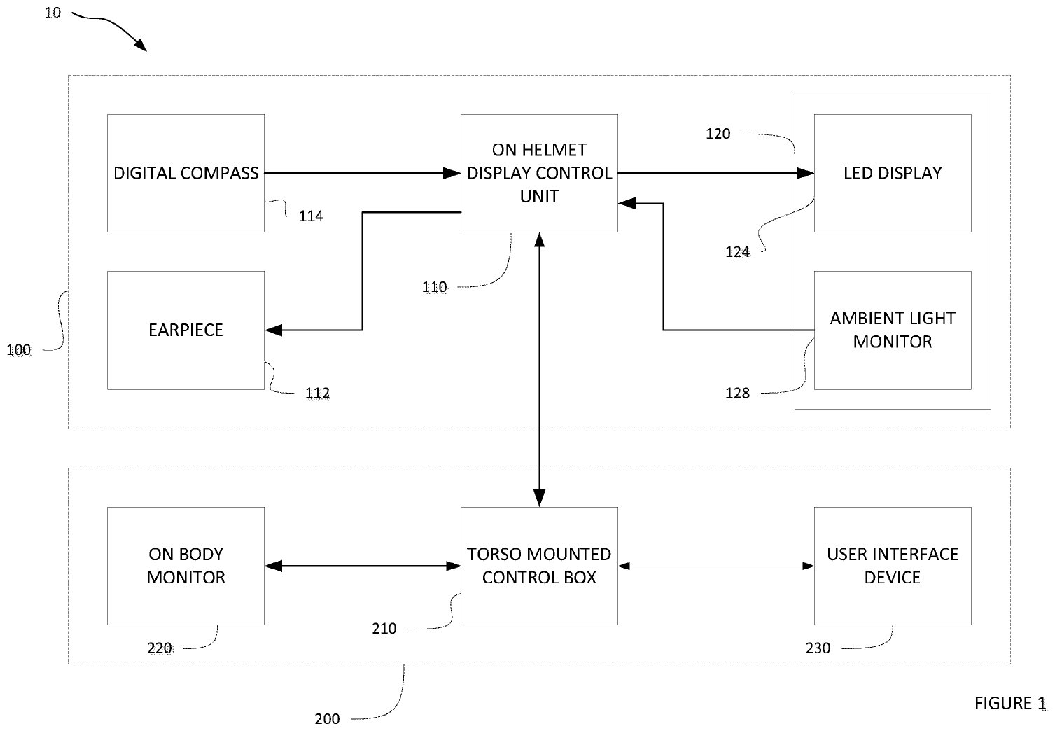

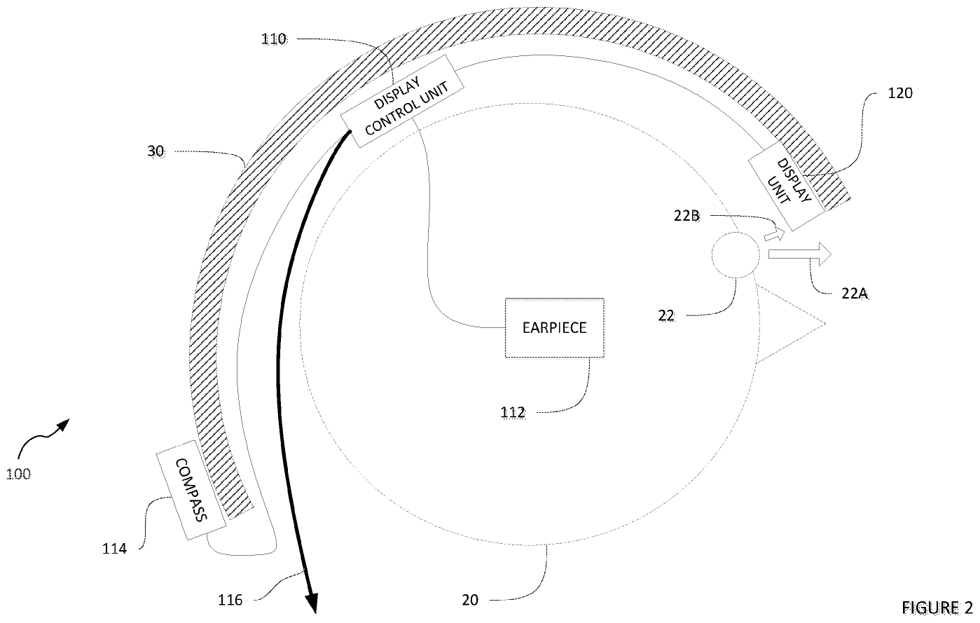

FIGS. 1 and 2 illustrate a general arrangement of a first specific embodiment. FIG. 1 illustrates the general arrangement in schematic form, while FIG. 2 illustrates the head mounted components of the embodiment in physical location.

A display system 10 is illustrated in FIG. 1. The display system 10 comprises two assemblies, both outlined in broken line. A helmet mounted assembly 100 is in wired communication with a body mounted assembly 200. In general terms, the body mounted assembly 200 provides data processing facilities and power to the helmet mounted assembly 100, which provides information imparting facilities to a user, and provides orientation information to the body mounted assembly 200.

The reader will appreciate that this is but one possible specific embodiment, and that other embodiments and arrangements can also be contemplated which can deliver benefits. For instance, the link between the helmet mounted technology and the body mounted technology could, in certain embodiments, be delivered by way of wireless technology. The reader will appreciated that, in such circumstances, power could not be readily distributed from the body mounted technology to the helmet mounted technology by wireless link, so some form of power storage facility would need to be provided in the helmet. Also, the present disclosure contemplates the continual trend towards miniaturisation of technology, and the expectation that arrangements could be made to implement the whole described arrangement and facilities in technology installed in devices to be borne in or on the helmet of the user, without recourse to body mounted technology.

The body mounted assembly 200 comprises a torso mounted control box 210, connected to an on body monitor 220 and a user interface device 230. The on body monitor 220 and the user interface device 230 are connected to the torso mounted control box 210, which fulfills a central coordinating role. Radio communications facilities (to be described in detail in due course) are implemented by way of the body mounted assembly—in this embodiment such facilities are provided by the torso mounted control box, but in other embodiments such facilities could be implemented in the user interface device or in a helmet mounted facility.

The connection between the on body monitor 220 and the torso mounted control box 210 may be by way of a data and power cable, or it may be by wireless connection. The wireless connection can be implemented by way of a standardised communications protocol such as Bluetooth. Likewise, the connection between the user interface device 230 and the on body monitor 220 can be wired or wireless. In this case, the user interface device 230, is implemented, in this example, by a smart phone. Using a standard operating system such as implemented as a smart phone, it is possible to establish a network between the smart phone of the user interface device 230 and the control box 210. This could provide an enhanced indications connection as compared with Bluetooth or Wi-Fi connections.

The on body monitor 220 in this embodiment comprises monitoring devices for monitoring specific characteristics of the user, such as heart rate, respiration rate, body temperature and so on, which may be useful to the further use of the device. For example, it may be useful to be able to convey to the user an alert that a biometric is out of safe range and that medical attention should be obtained.

As noted above, the user interface device 230 is implemented as a smart phone. User interface facilities are provided by the smart phone using a device optimised application (also known as an app) suitable to integrate with facilities of the control box 210. By such an app, a user can be conveyed complex pieces of information, and can select desired configurations of the devices of the embodiment.

It will be appreciated that, in certain implementations, the user interface device 230 can be dispensed with. An operative may be provided with only the helmet mounted display device, to be described, and a body mounted assembly, configuration of which may be restricted to a supervisory role. In such embodiments, the torso mounted control box may comprise one or more simple control switches for use by the user; this allows limited control of the device by an operative. This enables deployment of devices to users with limited training or know-how in the use of technology, without expectation that they will have to engage in a sophisticated way with the configuration of the device, and it can simply be used to convey basic instructions to such users.

The helmet mounted assembly 100 comprises an on helmet display control unit 110 which provides a central control role within the helmet domain. Connected to the on helmet display control unit 110, is a digital compass 114 and an earpiece 112. As before, these can be wired connections or wireless connections. A display unit 120 comprises an LED display 124 and an ambient light monitor 128. It is desirable that the LED display 124 and the ambient light monitor 128 are integrated and/or adjacent to each other, so that the ambient light monitor 124 is monitoring ambient light at the position at which the LED display 124 operates.

In use, the on helmet display control unit 110 is operable to receive signals from the torso mounted control box 210 of the body mounted assembly 200, such signals conveying commands as to information to be displayed at the LED display 124. Such signals may be encoded in a variety of different ways, such as binary words, to be decoded into parallel powerlines to the LED display 124. The ambient light monitor 128 provides a signal back to the on helmet display control unit 110 which indicates the intensity of ambient light, and therefore the brightness to which the LEDs of the LED display 124 should be powered up to.

Furthermore, the on helmet display control unit 110 is operable to seek and to receive signals from the digital compass 114, indicative of the bearing of the user's head. This can be useful, in combination with commands received from the torso mounted control box 210 to convey direction information to the user via illuminated LEDs of the LED display 124.

In a simple embodiment, the helmet mounted assembly may comprise only the display control unit 110 and the LED Display 124, linked to the torso control box 210. The other head mounted elements enhance its basic performance.

Connection between the torso mounted control box 210 and the on helmet display control unit 110 is by way of a power and data cable. This delivers power to the helmet mounted assembly 100 from the body mounted assembly 200. As will be appreciated by the reader, a source of electric power is provided on the body, and this may be in the form of a battery or other rechargeable electrical energy source. This is not illustrated, for the clarity of the reader.

As noted above, alternatively the torso-helmet data link may be implemented using wireless technology, with an electrical power source (e.g a battery) located on the helmet.

FIG. 2 illustrates the configuration of the helmet mounted assembly 200 with respect to a user 20 wearing a helmet 30. As illustrated, the aforementioned display control unit 110 is installed in the crown of the helmet 30, the display unit 120 is attached to the inside surface of the brim of the helmet 30, and the compass 114 is illustrated a fixed to the back, or nape of the helmet 30. The compass 114 is connected, as previously described, to the display control unit 110 by wired connection, as is the display unit 120. These wired connections are fed along the interior surface of the helmet. If supportive webbing or padding is provided within the helmet, the wiring can be fed behind this, to avoid interference with the user's head. The earpiece 112 is also connected to the display control unit 110, by wired connection. As previously noted, all of these wired connections can be replaced by wireless connections, as convenient.

The reader will recognise that this configuration is for example only, and that alternative locations for some of the described elements may be adapted to the geometry of the headwear to be employed by the user.

The eye 22 of the user 20 is indicated schematically. As indicated, a normal direction of gaze is indicated by a horizontal arrow marked 22A. An upward glance direction of gaze is indicated by a diagonal arrow marked 22B. It will thus be clear to the reader that, in normal use, the display unit does not impact upon the normal direction of gaze of the user, and that the intention is that the visual output of the display unit should be visible to the user in the upper field of vision, away from the main area of interest to be focused upon by the user.

In alternative arrangements, wherein it is expected that the headwear to be used by the user will more likely impinge upon the side or lower fields of vision (such as a respirator or protective goggles), then these areas may also be used to host display units, without detracting from the user's visual field.

To effect the connection with the body mounted assembly 200, a power and data cable 116 is shown extending from the display control unit 110, down the back of the helmet, and to the body of the user.

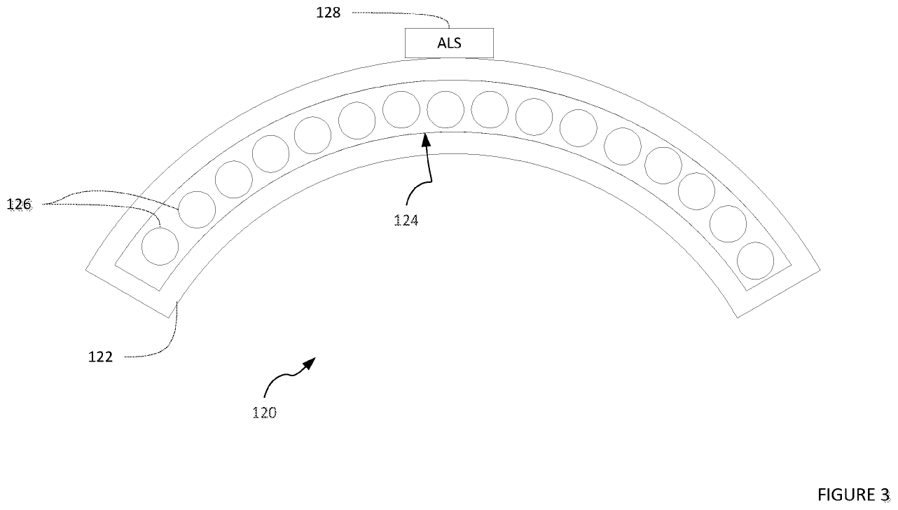

The display unit 120 is illustrated in further detail in FIG. 3. As shown, the display unit 120 comprises a mount 122 in which are mounted the LED display 124 comprising a plurality of light emitting diodes (LEDs) 126. As shown, these form a semi-circular row, to fit against the semi-circular form of the interior of the helmet 30. Additionally, the ambient light sensor 128 is affixed to the mount 122, adjacent to the LED display 124, to measure ambient light in the vicinity of the LED display 124. The ambient light sensor 128 returns an ambient light signal to the on helmet display control unit 110, on the basis of which the control unit 110 calculates a desirable brightness for elimination of LEDs of the LED display 124.

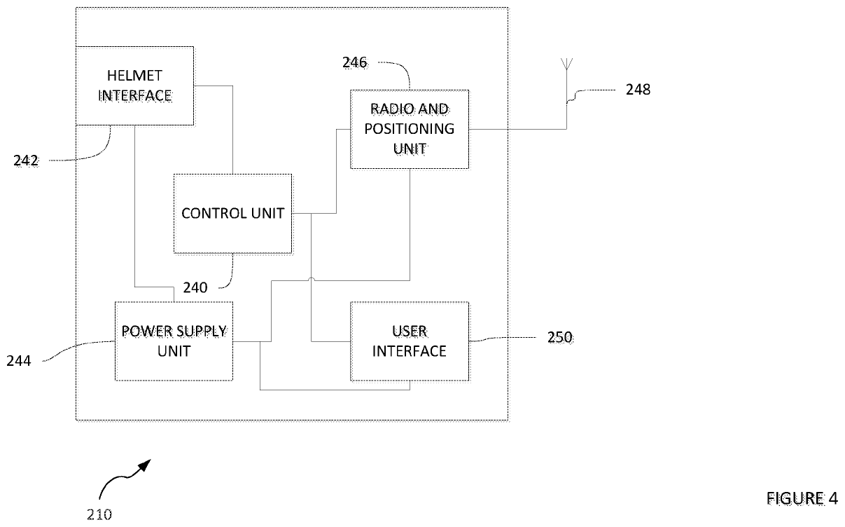

FIG. 4 is a schematic illustration of the torso mounted control box 210 previously described. The torso mounted control box 210 comprises a control unit 240, which provides central control facilities and processes to the rest of the box 210. The control box 210 further comprises a helmet interface 242, for connection with the power and data cable 116. In one embodiment, the data cable 116 is connected with a Quick Release (QR) connector to the torso helmet interface 242 (or at helmet end) which offers certain advantages in terms of user safety.

A power supply unit 244 supplies power to the other components of the torso mounted control box 210, and, via the helmet interface 242, to the helmet mounted assembly 100. It may also provide power to other elements of the body mounted assembly 200.

A radio and positioning unit 246, and associated antenna 248 provide radio communications facilities and positioning facilities, such as satellite based positioning facilities as defined by the GPS system. A user interface 250 provides a simple facility for a user to configure aspects of the body mounted assembly 200, such as via a keypad or other data entry system. It can also provide facility for interaction with an app installed on a smart phone, such as the smart phone implementing the user interface device 230 of the arrangement illustrated in FIG. 1.

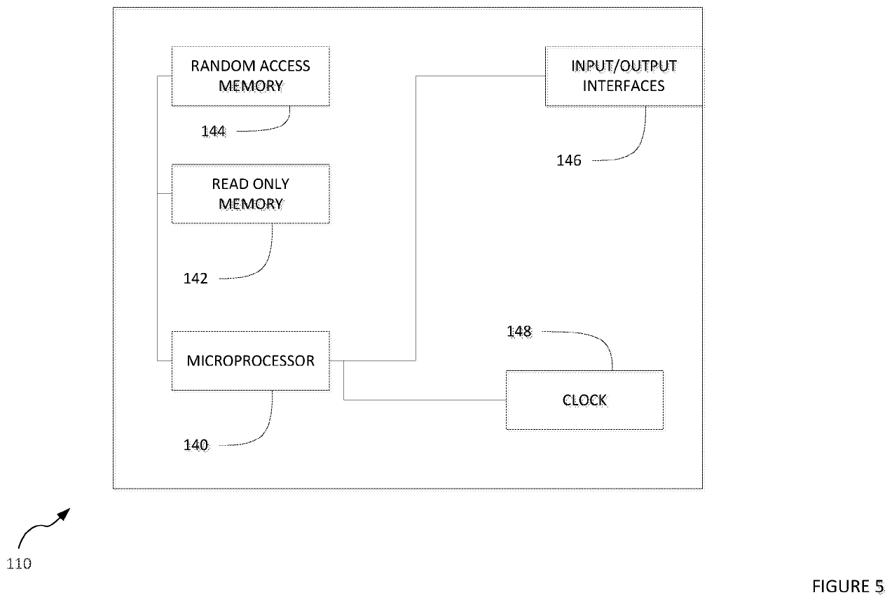

In this embodiment, the display control unit 110 is implemented by means of a general-purpose computer. This computer is illustrated in schematic terms in FIG. 5. It comprises a microprocessor 140, which has access to random access memory 142 and read-only memory 144. Various programs, and other software facilities are stored in read-only memory 142, for execution as required by the microprocessor 140. These will be described in due course.

Input output interfaces 146 are implemented, to enable communication between the computer implemented control unit 110 and other devices of the helmet mounted assembly 100. As is generally the case, the computer implemented display control unit 110 also comprises a clock 148.

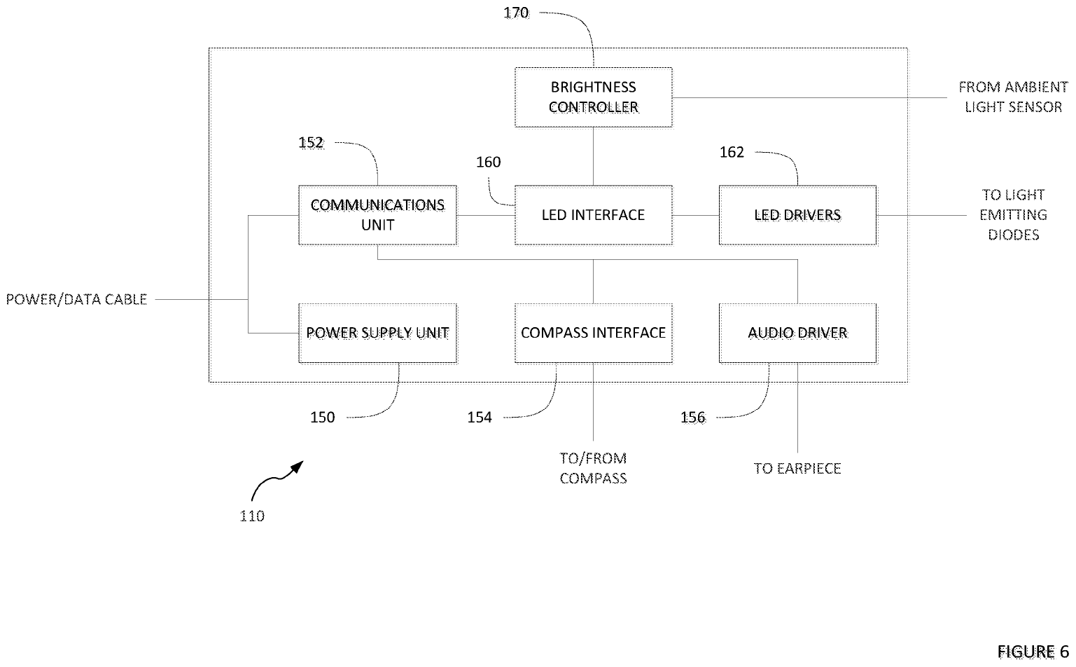

The display control unit 110 implements functional facilities, as illustrated in FIG. 6, such as by the execution of suitable software. Certain application-specific hardware may also be provided. As shown in FIG. 6, the skilled reader will appreciate that all facilities require a mixture of software and hardware implementation, and the balance will be implementation dependent.

The display control unit 110 therefore comprises, in functional terms, a power supply unit 150 operable to receive a power supply from the power data cable 116 and to distribute it within the display control unit 110 and to other devices of the helmet mounted assembly 110. A communications unit 152 is configured to establish a data communications channel on the power data cable 116 with the body mounted assembly 200, specifically with the torso mounted control box 210.

The communications unit 152 is also configured to establish an interaction with the digital compass, via implementation of a compass interface 154 and with the earpiece 116 via an audio driver 156. Alternatively audio input tones may be generated within the torso module 210 and routed to the user's audio headset via the radio, in which case the audio input driver 156 would not be needed on the head.

An LED interface 160 interprets commands received at the communications unit 152 and converts them into driver signals for the individual LEDs 126 of the display unit 120. A plurality of LED drivers 162 take the driver signals and convert them into driver voltages to be output to the LEDs 126. The LED interface 160 performs its calculation of driver signals based on a brightness control signal received from a brightness controller 170, in receipt of a signal from the ambient light sensor 128.

A number of examples of use of the above system 10 will now be described, to demonstrate the scope of facilities that may be provided.

As will be appreciated by the reader, processing capabilities are provided, in the system 10, both in the helmet mounted assembly 100 and the body mounted assembly 200. It is a matter of design preference and specific circumstances as to whether data processing takes place at either or both of these facilities, or “upstream” in a networked data processing capability to which the system 10 can communicate by radio.

So, where the present disclosure specifies, for example, that a particular data processing function is performed at, say, the torso mounted control box 210, the reader will appreciate that this is not prescriptive for embodiments in general.

As illustrated, it is envisaged that the torso mounted control box 210 will interface with the user and wider world via a control device such as the illustrated user interface device 230 which, in embodiments, can be a control surface (smartphone or tablet), via a data radio, and with sensors such as on-body monitors 220. It will conduct local processing in this example in order to define whether the device should be activated to display data, the nature of the data to be displayed, or the bearing of the device (useful if bearing based information is to be displayed to a user). All of these functionalities can be controlled by way of a user interface, such as a graphical user interface to be presented at the user interface device 230.

In certain embodiments, the user interface device 230 may be optional, or only temporarily engaged with the rest of the system. That is, sufficient functionality may be delivered to an operative with basic training, without the need for additional user interface facilities as might be provided by a user interface of the type described. System maintenance and/or configuration may be conducted, in such cases, by a senior operative connecting such a user interface device to the system on a temporary basis, or by establishing data radio contact with the torso mounted control box on a temporary or permanent basis.

It may be desirable to restrict authority to maintain or configure the system, to avoid misuse. Permanent radio connection may, in some circumstances, be undesirable due to the data security implications that may be consequent. The reader will appreciate that such considerations will be specific to each deployment.

Messages of pre-determined format will pass between the torso mounted control box 210 and the on helmet display control unit 110 in use. Such messages will be the outcome of processing on each respective device. A typical message from the torso mounted control box 210 to the on-helmet display control unit 110 could be to configure “data to display” information. This “data to display” information instructs the on-helmet display control unit 110 as to the information that should be displayed at the display unit 120, and how this information should be displayed.

So, for instance, the “data to display” information can include user-defined information as to the desired brightness of the display. This can then be used by the on-helmet display control unit 110 to control the brightness of illuminated LEDs 126 of the display unit 120. In one embodiment, processing takes place on board the on-helmet display control unit, to combine the user-defined desired brightness information, with information received from the ambient light monitor 128, to produce a combined brightness indicator governing the brightness to which the LEDs 126 should be driven. One setting for user-defined brightness may indicate to the on-helmet display control unit 110 that it should determine the brightness solely with regard to the ambient light monitor 128, that is, on an “automatic” basis without user control. This setting might be available to a supervisory operative setting up the unit in maintenance mode. Likewise, another setting might be provided which entirely over-rides the influence of the ambient light measurement, and in such cases the user-defined brightness setting (potentially also set up by a supervisory authority) may solely govern the brightness of the LEDs 126 when driven.

The messages to the on-helmet display control unit 110 may further configure the latter as to what information will be displayed at the display unit 120. For instance, it may be the case that a function of the on-helmet display control unit 110 is to continuously display an indicator of bearing (perhaps with regard to North or an agreed direction or target) on the display unit 120. This could be configured by a message to the on-helmet display control unit 110 from the torso mounted control box 210 as a result of user interaction with the user interface device 230. Equally, a message could provide that such a function be disabled.

Further “data to display” configuration messages can be defined, such as concerning the display of power consumption information, for instance a “power low” indicator, or the display of a threat warning indicator, such as detection of the presence of an incoming threat to safety (e.g. an oncoming train).

In the case of a “power low” indicator, the presently illustrated embodiment has a single power supply unit 244, in the body mounted assembly 200. Thus, for implementation of a “power low” indicator, this implicates the production of a signal by the power supply unit 244. This can be delivered as a power indicator message to the head mounted assembly 100. Two examples are provided for the power indicator message.

In a first example, the power indicator message is a warning message indicating simply that available power is below a certain threshold. In a refinement of this example, more than one threshold can be defined (such as at 30% power remaining and at 10% power remaining), and messages defined which indicate each of these scenarios to the head mounted assembly 100. The display control unit 110 can then use this message to produce an appropriate alert message at the display unit 120, indicative of the diminishing available power. The exact format of this display alert is an implementation specific design consideration.

In a second example, the power indicator message bears information indicating the amount of power remaining available for consumption in the power storage facility of the power supply unit 244. This could be a numeric information entity, such as a percentage, or a coarser indicator such as a selected one of a predetermined set of descriptors, such as “full”, “high”, “moderate”, “low”, “very low”.

In this case, the display control unit 110 could be configured in at least two ways. In a first configuration, the information received in the power indicator message could be translated into a display indicative of the amount of power remaining. So, for example, a typical display may illuminate a number of the LEDs 126 in proportion with the amount of power remaining. In a second configuration, the information received in the power indicator message could be set against a pre-determined threshold (which might be configurable by a user, or by a senior authority, as appropriate) and, if the power remaining is below, or at least not above, that threshold, then a low power warning message may be displayed.

The display of the power message may be automatic, in that it appears without user interaction as soon as the power level dips below the threshold, or it may display transiently in response to user input action, for instance the pressing of a button of the simple user interface 250.

Processing to determine where such information, and the format of such information as presented on the display unit 120, is formulated, can be located on the head mounted assembly 100 or the torso mounted assembly 200, to suit specific implementations.

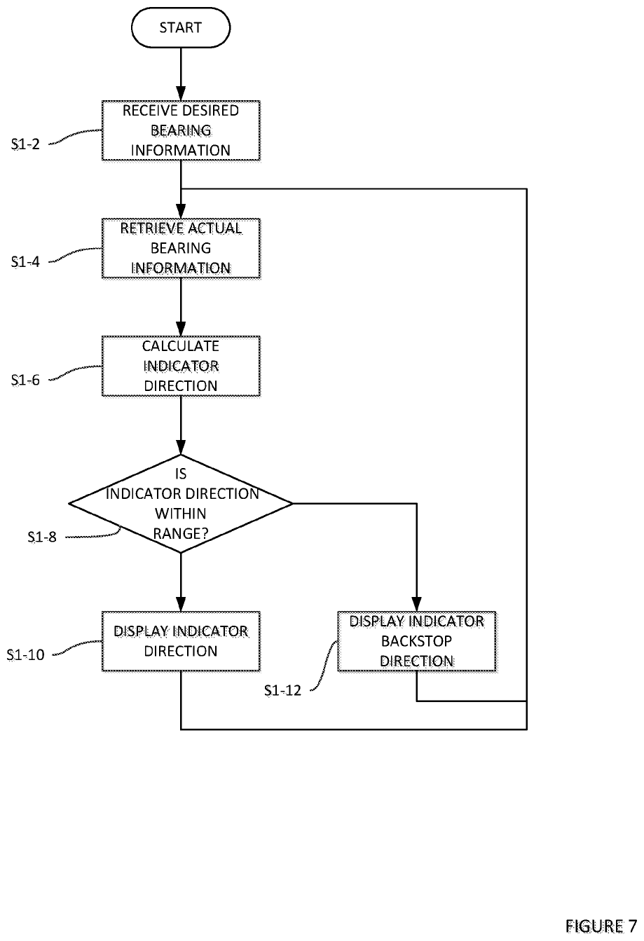

In an example of use of the display system 10, as shown in FIG. 7, the user interface device 230 offers a user interface facility to a user to define a bearing of interest to be set. For instance, an operative may be instructed to monitor for visual activity in a particular direction, or may be set to travel in a particular direction. Then, this bearing of interest is received, in step S1-2, at the processing facility hosting the process. In this example, the process is executed at the display control unit 110 but the reader will understand that this is a software design consideration.

Then, in step S1-4, the display control unit 110 obtains (either by requesting, or because it is periodically received) a bearing from the compass 114. On the basis of the desired bearing, and the actual bearing (indicating the azimuthal orientation of the helmet), an indicator direction to be displayed to the user is calculated in step S1-6. It is then determined, in step S1-8, whether this indicator direction can be displayed on the LED display 124 or whether it is beyond either the left or right hand bounds of the range available.

If the indicator direction can be displayed, then in step S1-10, an instruction is given to the LED interface 160 to drive a suitable indication (e.g. illumination of one LED in a position corresponding to the indicator direction) on the LED display 124.

On the other hand, if the indicator direction is beyond either the left hand or right hand bound of the LED display 124, then in step S1-12 a suitable indication is made on the LED display 124, for instance by illumination of one or more LEDs at the corresponding end of the LED display 124, and this indication can be made distinguishable from other possible indications such as by flashing intermittently or by designation of a particular colour to that state.

The process as envisaged can be made to continually update by returning to step S1-4, to acquire local bearing again and to ensure that the indicated direction to the user is kept current.

Similar processes can be constructed for indicating other information to the user. For instance, a desired geolocation, either for a user to travel to or for a user to focus attention on, can be conveyed in a message to the display control unit. The display control unit 110 can acquire information for a desired geolocation, and information for current geolocation (such via GPS). Then, trajectory information can be determined, in the form of a vector describing direction and range to the location of interest. This direction of interest can, again, be indicated on the display unit. Directions within the bounds represented by the display unit can be directly displayed; directions outside those bounds can be displayed such as by indicating an “out of bounds” indicator at the respective end of the LED array. Distance or range could be indicated in numerous ways. For instance, colour might be used to distinguish between near or far objects, or distances in between. As the reader will appreciate, the display system 10 is capable of low precision information display, and it is not expected that high precision information will need to be displayed by this device.

Again, as a target moves, or as the user moves, the indications may be continually updated to enable displayed information to remain current and useful to the user.

While certain embodiments have been described, these embodiments have been presented by way of example only, and are not intended to limit the scope of the invention. Indeed, the novel methods, devices and systems described herein may be embodied in a variety of forms; furthermore, various omissions, substitutions and changes in the form of the methods and systems described herein may be made without departing from the spirit of the invention. The accompanying claims and their equivalents are intended to cover such forms or modifications as would fall within the scope and spirit of the inventions.

1. A display system for displaying information to a user, the display system comprising:
a display comprising a plurality of light emitting elements;
a mount configured to be arranged so as to position the display in a region of a field of view of a user away from the normal direction of gaze of the user, and
a driver unit operable to selectively drive the plurality of light emitting elements so as to convey information according to selection of elements to drive.

2. A display system in accordance with claim 1 wherein the mount is configured to be arranged so as to position the display:
in a region of the field of view above the normal direction of gaze of the user; or
in a region of the field of view below the normal direction of gaze of the user; or
in a region of the field of view beside the normal direction of gaze of the user.

3. A display system in accordance with claim 2, wherein the mount is configured to be arranged so as to position the display in a region of the field of view above the normal direction of gaze of the user, and the display comprises two pluralities of light emitting elements, one per respective eye of the user, to accommodate an intraocular gap between the eyes of the user and to avoid illumination of elements of one plurality being visible to the other eye.

4. A display system in accordance with claim 2, wherein the mount is configured to be arranged so as to position the display in a region of the field of view above the normal direction of gaze of the user, above both eyes of the user, and the driver unit is operable to disable illumination of light emitting elements of the display which are in use visible to both eyes of the user.

5. A display system according to claim 1, wherein the mount comprises an attachment for attaching the display to any one of an item of headwear, eyewear, or face-covering equipment, and an attachment for attaching the display to the head of a user, and wherein the mount is configured such that, in use, the light emitting elements emit light directionally towards the user.

6. (canceled)

7. (canceled)

8. A display system according to claim 1 wherein the driver unit is operable to selectively drive the light emitting elements, including to control the intensity level of light emitted by each light emitting element, and at least one of:
the display system comprises a light sensor operable to determine a measure of ambient light conditions and the driver unit is operable to control the intensity level on the basis of the measure of ambient light conditions; and
the display system is operable to receive a brightness control request, wherein the driver unit is operable to control the intensity level on the basis of the brightness control request; and
the display system includes a brightness request user input device operable to receive a user input action corresponding to a brightness control request.

9. (canceled)

10. (canceled)

11. (canceled)

12. A display system in accordance with claim 1 wherein the driver unit is operable to control colour of light selectively emitted by each light emitting element.

13. A display system in accordance with claim 1 comprising a display option user input device operable to receive a user input action indicative of a display operation control request, to determine whether the driver unit is configured to drive the light emitting elements to emit light, or whether the driver unit is in a disabled mode of operation.

14. A display system according to claim 1, wherein the display system further includes a bearing sensor for attachment to the head or headwear of the user and configured to provide bearing information comprising an indication of bearing of the head of the user to the driver unit; and wherein the driver unit is operable to selectively drive the plurality of light emitting elements so as to provide an output to the user in accordance with the bearing information; and wherein the bearing sensor is a compass operable to generate an electronic output corresponding to magnetic bearing.

15. A display system in accordance with claim 9 and comprising a bearing operation control user input device operable to receive a user input action indicative of a bearing operation control request, the driver unit being responsive to a bearing operation control request to selectively drive the light emitting elements on the basis of the bearing information to emit light.

16. (canceled)

17. A display system in accordance with claim 9 wherein the compass is a digital magnetic compass.

18. A display system according to claim 9, wherein the display system is operable to receive target location information defining a target location, and to determine, on the basis of that target location and the user location an indication of relative direction of said target, wherein the driver unit is operable to selectively drive the plurality of light emitting elements so as to indicate to a user the relative direction of said target.

19. A display system according to claim 12 wherein the driver unit is operable to selectively drive the plurality of light emitting elements so as to indicate to a user relative distance of said target.

20. A display system in accordance with claim 1, further comprising a user location sensor for providing location information indicative of the location of a user and configured to deliver user location data to the driver unit; and wherein the driver unit is operable to selectively drive the plurality of light emitting elements so as to provide an output to the user in accordance with the location information.

21. A display system in accordance with claim 14 and comprising a location operation control user input device operable to receive a user input action indicative of a location operation control request, the driver unit being responsive to a location operation control request to selectively drive the light emitting elements on the basis of the location information to emit light, and at least one of:
the user location sensor is operable to continuously update the user location data; and
the user location sensor is a geolocation device, and the geolocation device is operable to receive geolocation signals and, on the basis of the geolocation signals, to calculate a user geolocation.

22. (canceled)

23. (canceled)

24. (canceled)

25. A display system according to claim 1, wherein the light emitting elements are arranged in a linear juxtaposition.

26. A display system according to claim 1, wherein the light emitting elements are arranged in a two dimensional array.

27. A display system according to claim 1, further comprising an audio device configured to deliver audio alerts to the user, and the driver is operable to generate an audio alert to coordinate with a display output event at the display.

28. (canceled)

29. A display system according to claim 18 wherein the driver is operable to generate an audio alert to coordinate with a change in display at the display.

30. An item of headwear, the item of headwear defining a brim for alignment with the face of a user of said headwear, and a display system according to claim 1, wherein the display of the display system is integrated with the brim.
